(19) United States
(12) Patent Application Publication
(10) Pub. No.: US 2007/0101186 A1
(43) Pub. Date: May 3, 2007

(54) Computer platform cache data remote backup processing method and system

(75) Inventor: Chih-Wei Chen, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/266,546

(22) Filed: Nov. 2, 2005

(51) Int. Cl. G06F 11/00

(52) U.S. Cl. 714/6

(57) ABSTRACT

A computer platform cache data remote backup processing method and system is proposed, which is designed for providing a main computer platform with a cache data remote backup capability through a backup computer platform; which is characterized by the provision of an interlinking mechanism between the main and backup computer platforms such that all the cache data in the main computer platform can be mirrored via the interlinking mechanism to the backup computer platform for backup, and when a failure occurs to the main computer platform, the mirrored copy of cache data is transferred to a permanent data storage unit. When the failed main computer platform resumes normal operation, it can then regain the lost cache data from the permanent data storage unit. This feature can help prevent the cache data in the main computer platform from loss due to abnormal operating conditions.

### BACKGROUND OF THE INVENTION

1. Field of the Invention

This invention relates to information technology (IT), and more particularly, to a computer platform cache data remote backup processing method and system which is designed for use in conjunction with a computer platform, such as a network server, for providing a cache data remote backup processing function that can be activated in the event of a failure to the computer platform (such as when system crash or power failure occurs) to make a permanent backup copy of the cache data in the computer platform by way of a backup computer platform to a permanent storage unit, such as a hard disk unit.

2. Description of Related Art

An enterprise network system is typically composed of a cluster of Web servers which include main servers and backup servers such that when any one of the main servers fails, such as due to power failure or system crash, a backup server can be immediately used to replace the failed main server. This backup capability allows the network system to maintain normal Web services to the clients in the event of a failure to the main servers without being disrupted.

In practical application, however, when an abnormal operating condition occurs to a main server, there are usually still many cache data blocks stored in the cache memory of the main server which have been refreshed but not yet permanently stored back to their original programs. Therefore, even though the failed main server can be replaced by a backup server, the cache data in the failed main server would be nonetheless permanently lost.

### SUMMARY OF THE INVENTION

It is therefore an objective of this invention to provide a computer platform cache data remote backup processing method and system which allows the cache data in a main server to be permanently saved to a permanent data storage unit, such as a hard disk, in the event of a failure to the main server, so as to prevent the cache data in the failed main server from loss due to abnormal operating conditions.

The computer platform cache data remote backup processing method and system according to the invention is designed for use in conjunction with a computer platform, such as a network server, for providing a cache data remote backup processing function that can be activated in the event of a failure to the computer platform (such as when system crash or power failure occurs) to make a permanent backup copy of the cache data in the computer platform by way of a backup computer platform to a permanent storage unit, such as a hard disk unit.

The computer platform cache data remote backup processing method according to the invention comprises: (1) establishing an interlinking mechanism between the main computer platform and the backup computer platform; (2) during actual operation, monitoring the refresh and backup status of each data block stored in the cache memory unit of the main computer platform; and in the event of a cache data block being refreshed, issuing a backup refresh enable message and transfer this backup refresh enable message via the interlinking mechanism to the backup computer platform; (3) on the backup computer platform, responding to the backup refresh enable message by making a mirrored copy of the current cache data stored in the cache memory unit of the main computer platform, and storing the mirrored copy of cache data to a cache data backup memory module; and (4) in the event of a failure to the main computer platform, transferring the mirrored copy of cache data stored in the cache data backup memory module to a permanent data storage unit.

In architecture, the computer platform cache data remote backup processing system according to the invention is based on a distributed architecture comprising: (A) a main-side unit; and (B) a backup-side unit; wherein the main-side unit is integrated to the main computer platform, and which includes: (A1) a main-side interlinking module, which is integrated to the main computer platform for the main computer platform to exchange data with the backup computer platform; and (A2) a cache data mirroring module, which is integrated to the main computer platform, and which is capable of monitoring the refresh and backup status of each data block stored in the cache memory unit of the main computer platform, and in the event of a cache data block being refreshed, capable of issuing a backup refresh enable message and activating the main-side interlinking module to transfer this backup refresh enable message to the backup computer platform; and wherein the backup-side unit is integrated to the backup computer platform, and which includes: (B1) a backup-side interlinking module, which is integrated to the backup computer platform for the backup computer platform to receive data and messages from the main computer platform, including backup refresh enable message and cache data; (B2) an abnormal operating condition monitoring module, which is integrated to the backup computer platform, and which is capable of remotely monitoring the operating condition of the main computer platform via the interlinking mechanism provided by the main-side interlinking module and the cache data mirroring module; and in the event of an abnormal operating condition, capable of responding by issuing an abnormal operating condition message; (B3) a cache data backup module, which is integrated to the backup computer platform, and which is capable of responding to the backup refresh enable message received by the backup-side interlinking module from the main-side unit by making a mirrored copy of the current cache data stored in the cache memory unit of the main computer platform, and storing the mirrored copy of cache data to a cache data backup memory module; and (B4) a mirrored cache data permanent storage module, which is integrated to the backup computer platform, and which is capable of responding to the abnormal operating condition message issued by the abnormal operating condition monitoring module by transferring the mirrored copy of cache data currently stored in the cache data backup memory module to a permanent data storage unit.

The computer platform cache data remote backup processing method and system according to the invention is characterized by the provision of an interlinking mechanism between the main computer platform and the backup computer platform such that all the cache data in the main computer platform can be mirrored via the interlinking mechanism to the backup computer platform for backup, and in the event of a failure to the main computer platform, the mirrored copy of cache data in the backup computer platform is transferred for permanent storage on a permanent data storage unit, such as a hard disk. When the failed main computer platform resumes normal operation, it can then regain the lost cache data from the permanent data storage unit. This feature can help prevent the cache data in the main computer platform from loss due to abnormal operating conditions such as power failure or system crash.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application and distributed architecture of the computer platform cache data remote backup processing system of the invention; and

FIG. 2 is a schematic diagram showing more detailed internal architecture of the computer platform cache data remote backup processing system of the invention.

### DETAILED DESCRIPTION OF PREFERRED EMBODIMENTS

The computer platform cache data remote backup processing method and system according to the invention is disclosed in full details by way of preferred embodiments in the following with reference to the accompanying drawings.

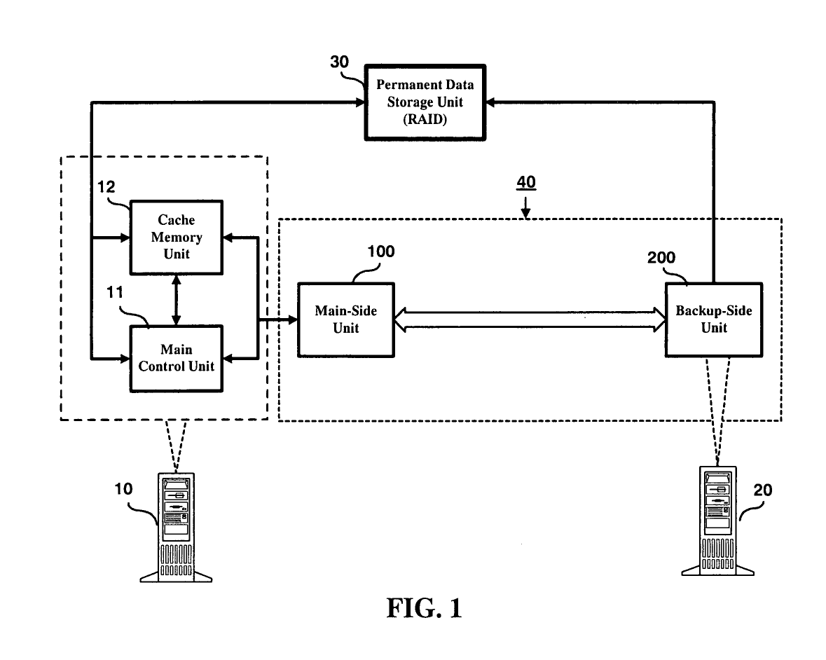

FIG. 1 is a schematic diagram showing the application and distributed architecture of the computer platform cache data remote backup processing system according to the invention (as the part enclosed in the dotted box indicated by the reference numeral 40). As shown, the computer platform cache data remote backup processing system of the invention 40 is designed for use in a distributed manner with a main computer platform 10 and a backup computer platform 20, where the main computer platform 10 includes a main control unit 11 and at least one cache memory unit 12, for the purpose of providing a cache data remote backup processing function for the cache data stored in the cache memory unit 12 that can be activated in the event of a failure to the main computer platform 10 (such as when system crash or power failure occurs) to make a permanent backup copy by way of the backup computer platform 20 to a permanent data storage unit 30, such as a RAID (Redundant Array of Independent Disks) unit. This backup capability allows the cache data in the main computer platform 10 to be securely prevented from loss due to failure of the main computer platform 10. In practical implementation, for example, the main computer platform 10 and the backup computer platform 20 are each a network server.

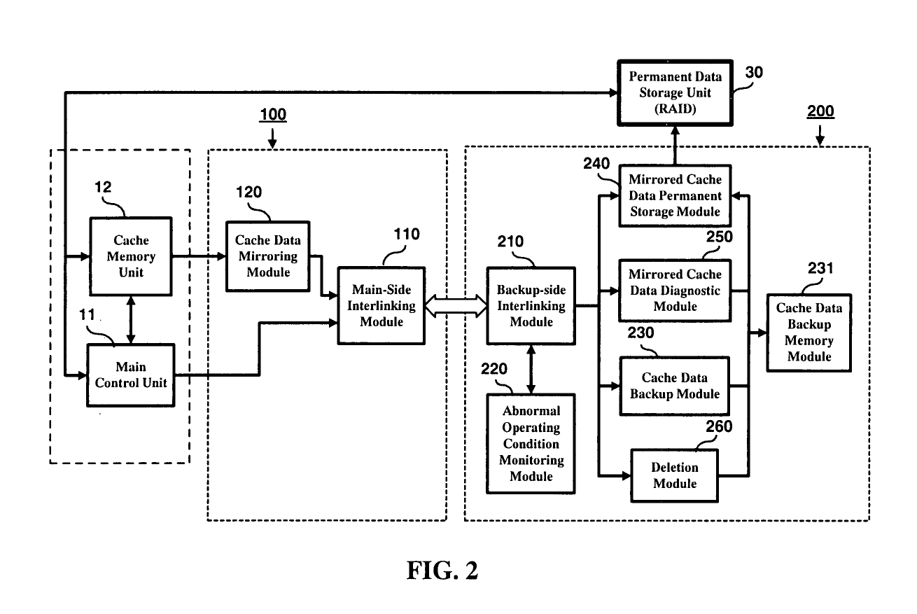

As shown in FIG. 1, the computer platform cache data remote backup processing system of the invention 40 is based on a distributed architecture whose object-oriented component model comprises at least 2 separate units: (A) a main-side unit 100 installed on the main computer platform 10; and (B) a backup-side unit 200 installed on the backup computer platform 20; and wherein as shown in FIG. 2, the main-side unit 100 includes: (A1) a main-side interlinking module 110; and (A2) a cache data mirroring module 120; while the backup-side unit 200 includes: (B1) a backup-side interlinking module 210; (B2) an abnormal operating condition monitoring module 220; (B3) a cache data backup module 230; and (B4) a mirrored cache data permanent storage module 240; and can further optionally includes: (B5) a mirrored cache data diagnostic module 250; and (B6) a deletion module 260.

Firstly, the respective attributes and behaviors of the constituent modules 110, 120 of the main-side unit 100 are described in details in the following.

The main-side interlinking module 110 is integrated to the main computer platform 10, and which cooperates with the backup-side interlinking module 210 of the backup-side unit 200 installed on the backup computer platform 20 to provide an interlinking mechanism between the main computer platform 10 and the backup computer platform 20, for the main computer platform 10 and the backup computer platform 20 to exchange messages, data, and cache data. In practical implementation, for example, the main-side interlinking module 110 and the backup-side interlinking module 210 are interconnected by means of network connections.

The cache data mirroring module 120 is integrated to the main computer platform 10, and which is capable of monitoring the refresh and backup status of each group of data (such as each block of data) stored in the cache memory unit 12 of the main computer platform 10, and in the event of a cache data block being refreshed, capable of issuing a backup refresh enable message and activating the main-side interlinking module 110 to transfer the backup refresh enable message to the backup computer platform 20.

Next, the respective attributes and behaviors of the constituent modules 210, 220, 230, 240, 250, 260 of the backup-side unit 200 are described in details in the following.

The backup-side interlinking module 210 is integrated to the backup computer platform 20, and which cooperates with the main-side interlinking module 110 of the main-side unit 100 installed on the main computer platform 10 to provide an interlinking mechanism between the backup computer platform 20 and the main computer platform 10, for the backup computer platform 20 and the main computer platform 10 to exchange messages, data, and cache data.

The abnormal operating condition monitoring module 220 is integrated to the backup computer platform 20, and which is capable of remotely monitoring the operating condition of the main computer platform 10 via the interlinking mechanism provided by the main-side interlinking module 110 and the cache data mirroring module 120. In the event of an abnormal operating condition of the main computer platform 10, the abnormal operating condition monitoring module 220 is capable of responding to this event by issuing an abnormal operating condition message.

The cache data backup module 230 is integrated to the backup computer platform 20, and which is capable of responding to the backup refresh enable message received by the backup-side interlinking module 210 from the main-side unit 100 by making a mirrored copy of the current cache data stored in the cache memory unit 12 of the main computer platform 10, and then storing the mirrored copy of cache data to a cache data backup memory module 231 on the backup computer platform 20.

The mirrored cache data permanent storage module 240 is integrated to the backup computer platform 20, and which is capable of responding to the abnormal operating condition message issued by the abnormal operating condition monitoring module 220 by transferring the mirrored copy of cache data currently stored in the cache data backup memory module 231 to a permanent data storage unit 30. In practical implementation, for example, the permanent data storage unit 30 can be either a RAID (Redundant Array of Independent Disks) networked to the main computer platform 10 and the backup computer platform 20, or a dedicated hard disk unit of the backup computer platform 20.

The mirrored cache data diagnostic module 250 is integrated to the backup computer platform 20, and which is capable of performing a diagnostic procedure on the mirrored copy of cache data stored in the cache data backup memory module 231 of the backup computer platform 20 to check whether the mirrored copy of cache data can be reliably transferred for permanent storage on the permanent data storage unit 30. In practical implementation, for example, the mirrored cache data diagnostic module 250 is configured to receive a set of commands and cache data via the interlinking mechanism between the main computer platform 10 and the backup computer platform 20 (i.e., the interlinking mechanism provided by the main-side interlinking module 110 and the backup-side interlinking module 210), where the received commands include, for instance, “Remote Write”, “Remote Dirty”, “Remote Mirror”, “Remote Sync”, “Remote Auto Sync On/Off”, and so on. Among these commands, the “Remote Write” command is used to activate the backup computer platform 20 to write some cache data into the permanent data storage unit 30; the “Remote Dirty” command is used to gain access to a listing of cache data blocks and related buffer information from the backup computer platform 20; the “Remote Mirror” command is used to gain access to a listing of mirrored cache data blocks and related buffer information from the backup computer platform 20; the “Remote Sync” command is used to request the backup computer platform 20 to write all the mirrored copy of cache data into the permanent data storage unit 30; the “Remote Auto Sync On/Off” command is used to turn on or off the auto sync function between the main computer platform 10 and the backup computer platform 20. The mirrored cache data diagnostic module 250 is capable of using these commands to perform a diagnostic procedure on the main computer platform 10 and the backup computer platform 20 to check whether the mirrored copy of cache data currently stored in the backup computer platform 20 can be reliably transferred for permanent storage on the permanent data storage unit 30. In practical implementation, for example, the diagnostic procedure includes a first step of writing the mirrored copy of cache data in a block-by-block manner into the permanent data storage unit 30, and then a second step of comparing each stored cache data block in the permanent data storage unit 30 with the corresponding cache data block stored in the cache data backup memory module 231 to check if the two blocks of cache data are identical.

The deletion module 260 is an optional module integrated to the backup-side unit 200 installed on the backup computer platform 20, and which is capable of being activated in the event that the current cache data stored in the cache memory unit 12 of the main computer platform 10 has been permanently stored into the permanent data storage unit 30 or any other permanent storage means, to thereupon delete the corresponding mirrored copy of cache data stored in the cache data backup memory module 231.

The following is a detailed description of an example of a practical application of the computer platform cache data remote backup processing system of the invention 40 during actual operation.

Referring to FIG. 1 and FIG. 2 together, during actual operation of the main computer platform 10, the main computer platform 10 will store a frequently-accessed portion of a computer program into the cache memory unit 12 for quick access to enhance overall processing speed. If the main computer platform 10 operates normally, the main control unit 11 of the main computer platform 10 will periodically write the cache data to a permanent data storage unit 30, such as a RAID unit networked to the main computer platform 10 or a dedicated hark disk unit on the main computer platform 10, so that the refreshed cache data can be permanently saved. Meanwhile, the cache data mirroring module 120 in main-side unit 100 of the computer platform cache data remote backup processing system of the invention 40 is activated to constantly monitor the refresh and backup status of each block of cache data stored in the cache memory unit 12 of the main computer platform 10. In the event of a cache data block being refreshed, the cache data mirroring module 120 will promptly issue a backup refresh enable message and activate the main-side interlinking module 110 to transfer the backup refresh enable message together with a copy of the refreshed cache data to the backup computer platform 20. On the backup computer platform 20, the backup-side interlinking module 210 will receive the backup refresh enable message and the refreshed cache data and transfer them to the cache data backup module 230. In response, the cache data backup module 230 will store the received copy of refreshed cache data into the cache data backup memory module 231. This cache data backup procedure will be repeatedly performed if the cache data stored in the cache memory unit 12 of the main computer platform 10 are repeatedly refreshed. Furthermore, after one block of cache data has been mirrored to the backup computer platform 20 (i.e., stored in the cache data backup memory module 231 on the backup computer platform 20), the mirrored cache data diagnostic module 250 can be activated to perform a diagnostic procedure to check whether the mirrored copy of cache data can be reliably transferred for permanent storage on the permanent data storage unit 30.

If the main computer platform 10 operates normally, the main control unit 11 of the main computer platform 10 will periodically write the cache data stored in the cache memory unit 12 into the permanent data storage unit 30. In this case, the cache data mirroring module 120 will issue a deletion enable message and transfer this deletion enable message via the main-side interlinking module 110 and the backup-side interlinking module 210 to the cache data backup module 230, thereby activating the cache data backup module 230 to delete the corresponding mirrored copy of cache data stored in the cache data backup memory module 231.

On the other hand, if an abnormal operating condition occurs to the main control unit 11 of the main computer platform 10, it will cause the abnormal operating condition monitoring module 220 to remotely detect this condition and respond by issuing a mirrored cache data permanent storage enable message to the mirrored cache data permanent storage module 240. In response, the mirrored cache data permanent storage module 240 will transfer the mirrored copy of cache data currently stored in the cache data backup memory module 231 to the permanent data storage unit 30 for permanent storage. This can assure that the cache data in the cache memory unit 12 of the main computer platform 10 will have a secured backup copy in the permanent data storage unit 30 when a failure occurs to the main computer platform 10. However, if all the cache data in the cache memory unit 12 have been saved to the permanent data storage unit 30 by the main control unit 11 before the failure occurs, the deletion module 260 will be activated to delete the mirrored copy of cache data in the cache data backup memory module 231.

In conclusion, the invention provides a computer platform cache data remote backup processing method and system for use with a main computer platform and a backup computer platform for providing the main computer platform with a cache data remote backup capability through the backup computer platform; and which is characterized by the provision of an interlinking mechanism between the main computer platform and the backup computer platform such that all the cache data in the main computer platform can be mirrored via the interlinking mechanism to the backup computer platform for backup, and in the event of a failure to the main computer platform, the mirrored copy of cache data in the backup computer platform is transferred for permanent storage on a permanent data storage unit, such as a hard disk. When the failed main computer platform resumes normal operation, it can then regain the lost cache data from the permanent data storage unit. This feature can help prevent the cache data in the main computer platform from loss due to abnormal operating conditions such as power failure or system crash. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform cache data remote backup processing method for use on a main computer platform and a backup computer platform, where main computer platform includes a main control unit and a cache memory unit, for providing the main computer platform with a cache data remote backup capability through the backup computer platform;
the computer platform cache data remote backup processing method comprising:
establishing an interlinking mechanism between the main computer platform and the backup computer platform;
during actual operation, monitoring the refresh and backup status of each data block stored in the cache memory unit of the main computer platform; and in the event of a cache data block being refreshed, issuing a backup refresh enable message and transfer this backup refresh enable message via the interlinking mechanism to the backup computer platform;
on the backup computer platform, responding to the backup refresh enable message by making a mirrored copy of the current cache data stored in the cache memory unit of the main computer platform, and storing the mirrored copy of cache data to a cache data backup memory module; and
in the event of a failure to the main computer platform, transferring the mirrored copy of cache data stored in the cache data backup memory module to a permanent data storage unit.

2. The computer platform cache data remote backup processing method of claim 1, wherein the main computer platform and the backup computer platform are each a network server.

3. The computer platform cache data remote backup processing method of claim 1, wherein the permanent data storage unit is an RAID (Redundant Array of Independent Disks) unit.

4. The computer platform cache data remote backup processing method of claim 1, further comprising:
performing a diagnostic procedure on the mirrored cache data stored in backup computer platform to check whether the mirrored cache data can be reliably transferred for permanent storage on the permanent data storage unit.

5. The computer platform cache data remote backup processing method of claim 1, further comprising:
in the event that the current cache data stored in the cache memory unit of the main computer platform has been permanently stored into a permanent data storage unit, deleting the mirrored copy of cache data stored in the cache data backup memory module.

6. A computer platform cache data remote backup processing system for use with a main computer platform and a backup computer platform, where main computer platform includes a main control unit and a cache memory unit, for providing the main computer platform with a cache data remote backup capability through the backup computer platform;
the computer platform cache data remote backup processing system being based on a distributed architecture comprising a main-side unit and a backup-side unit;
wherein
the main-side unit is integrated to the main computer platform, and which includes:
a main-side interlinking module, which is integrated to the main computer platform for the main computer platform to exchange data with the backup computer platform; and
a cache data mirroring module, which is integrated to the main computer platform, and which is capable of monitoring the refresh and backup status of each data block stored in the cache memory unit of the main computer platform, and in the event of a cache data block being refreshed, capable of issuing a backup refresh enable message and activating the main-side interlinking module to transfer this backup refresh enable message to the backup computer platform;
and wherein
the backup-side unit is integrated to the backup computer platform, and which includes:
a backup-side interlinking module, which is integrated to the backup computer platform for the backup computer platform to receive data and messages from the main computer platform, including backup refresh enable message and cache data;
an abnormal operating condition monitoring module, which is integrated to the backup computer platform, and which is capable of remotely monitoring the operating condition of the main computer platform via the interlinking mechanism provided by the main-side interlinking module and the cache data mirroring module; and in the event of an abnormal operating condition, capable of responding by issuing an abnormal operating condition message;
a cache data backup module, which is integrated to the backup computer platform, and which is capable of responding to the backup refresh enable message received by the backup-side interlinking module from the main-side unit by making a mirrored copy of the current cache data stored in the cache memory unit of the main computer platform, and storing the mirrored copy of cache data to a cache data backup memory module; and
a mirrored cache data permanent storage module, which is integrated to the backup computer platform, and which is capable of responding to the abnormal operating condition message issued by the abnormal operating condition monitoring module by transferring the mirrored copy of cache data currently stored in the cache data backup memory module to a permanent data storage unit.

7. The computer platform cache data remote backup processing system of claim 6, wherein the main computer platform and the backup computer platform are each a network server.

8. The computer platform cache data remote backup processing system of claim 6, wherein the permanent data storage unit is an RAID (Redundant Array of Independent Disks) unit.

9. The computer platform cache data remote backup processing system of claim 6, wherein the backup-side unit further includes:
a mirrored cache data diagnostic module, which is integrated to the backup computer platform, and which is capable of performing a diagnostic procedure on the mirrored cache data stored in backup computer platform to check whether the mirrored cache data can be reliably transferred for permanent storage on the permanent data storage unit.

10. The computer platform cache data remote backup processing system of claim 6, wherein the backup-side unit further includes:
a deletion module, which is capable of being activated in the event that the current cache data stored in the cache memory unit of the main computer platform has been permanently stored into a permanent data storage unit, and which is capable of thereupon deleting the mirrored copy of cache data stored in the cache data backup memory module.
